(19) United States
(12) Patent Application Publication
(10) Pub. No.: US 2015/0172563 A1
(43) Pub. Date: Jun. 18, 2015

(54) Incorporating advertising content into a digital video

(71) Applicants: Gabriel Jakobson, Alamo, CA (US); Steven Rueben, Las Vegas, NV (US)

(72) Inventors: Gabriel Jakobson, Alamo, CA (US); Steven Rueben, Las Vegas, NV (US)

(21) Appl. No.: 13/998,890

(22) Filed: Dec. 18, 2013

(51) Int. Cl. H04N 5/272; H04N 21/8541; H04N 21/81; G11B 27/30; H04N 5/781

(52) U.S. Cl. CPC H04N 5/2723; G11B 27/30; H04N 5/781; H04N 21/812; H04N 21/8541

(57) ABSTRACT

A computer-implemented method and system for incorporating advertisement into video-based digital media, comprising: providing a video in digital format wherein the video comprises a sequence of video frames; providing meta-data wherein the meta-data defines at least one surface in at least one of the video frames; providing an image, wherein the image is external to the video; incorporating the image into the at least one surface; and displaying the sequence of video frames wherein the sequence of video frames includes the image incorporated in the at least one surface. Attributes of the surface, such as lighting, shading, texture, curvature, etc. may be factored into a transformation function projecting the image onto the surface. To a viewer of the video, the incorporated advertisement may appear to be an integral part of the video.

### FIELD OF INVENTION

The present invention generally relates to advertisement placement in digital media. More particularly, the present invention relates to a system enabling display of external advertising content within playback of a video wherein the advertisement content appears integrated into the video.

BACKGROUND OF THE INVENTION

Digital videos, available in movie theaters, on DVDs, BluRay®, Youtube®, off of game consoles, smart phones and tablets, streamed from NetFlix®, Apple TV®, etc. are generally available in a variety of formats: .asp, 3GP, 3G2, .asf, .wma, .wmv, AVI, DivX, EVO, F4V, FLV, .mkv, .km3d, .mka, .mks, MP4, .m4a, .m4b, MPEG, MPEG TS, QuickTime®, BDAV MPEG-2, MFX, Ogg, .mov, .qt, RMVB, VOB_IFO, WebM, etc.

Digital Multimedia formats are often containers encapsulating data containing a movie stream, audio, subtitles, navigation menu, etc. For example, MPEG-4 Part 14 video files may also contain metadata including chapter markers, images, and hyperlinks. MP4 files can contain metadata as defined by the format standard, and in addition, can contain Extensible Metadata Platform (XMP) metadata. As another example, DivX Media Format (DMF) features: Interactive video menus, Multiple subtitles (XSUB), Multiple audio tracks, Multiple video streams (for special features like bonus/extra content, just like on DVD-Video movies), Chapter points, Other metadata (XTAG), Multiple format, etc.

In the prior art, movie-based advertising is external to the movie stream itself; i.e. does not modify the actual movie a viewer sees (one exception is product-placement within movies, such as James Bond driving a BMW, where a movie is filmed with the product placement and is unmodifiable thereafter). For example, movie theaters show commercials prior to a feature film. Youtube® superimposes advertisements in a container visible over a portion of a movie being played. Targeted advertising is often presented to viewers based on their demographics. For example, a person logged into Youtube® may see contextual advertising, presented “outside” the movie content itself, based on information Youtube® has on the user, such as their age, gender, preferences, etc.

### SUMMARY OF THE INVENTION

In general, a method and system for injecting external advertisement content into a movie such that, from a viewer's perspective, the advertisement content appears integrated with the movie itself. The advertisement content may be integrated with the movie by being graphically positioned at pre-determined regions within the movie. Display of the advertisement content may be accomplished by image transformation/projection matrices taking into account perspective, lighting, shadowing, textures, 3D attributes of objects/areas projection is applied to, etc. The achieved effect is one where, to a viewer, the advertisement content appears substantially indistinguishable from the movie into which the advertisement content is injected. Advertisement content may be placed/targeted such that multiple viewers watching the same movie may see different advertising based on their individual demographics and other attributes.

For example, a movie scene may include actors having a dialog in front of a bus, slowly driving in the background. The bus may display an advertisement on its side; however, as opposed to the prior art where the movie is filmed with the bus displaying a particular advertisement, in the present invention, the advertisement content is injected/merged with/superimposed on the bus from a source external to the movie stream. One viewer watching the movie (e.g. streamed via Apple TV®) may see the bus driving with an “iPhone 5S” ad on its side, while a second viewer, watching the very same movie at the very same time, may observe the same bus driving with a “Samsung Galaxy” on its side.

### DESCRIPTION OF THE DRAWINGS

For a more complete understanding of the present invention and further advantages thereof; references are now made to the following Detailed Description, taken in conjunction with the drawings, in which:

FIG. 1 is a generalized diagram illustrating overview of the present invention, where advertisement content is injected into a movie scene, in one preferred embodiment of the present invention.

FIGS. 2a-2c are generalized block diagrams illustrating meta data containing references to advertisement content being incorporated into a movie stream, in various possible embodiments of the present invention.

FIG. 3 is a generalized flow diagram illustrating a system in which advertisement content may be injected into a movie frame, in one possible embodiment of the present invention.

FIG. 4 is a generalized block diagram illustrating components of a system for injecting advertisement content into a video stream, in one possible embodiment of the present invention.

FIGS. 5a-5c are generalized block diagrams illustrating an overview of a method for incorporating external content in a digital video via meta data, in one possible embodiment of the present invention.

FIG. 6 is a generalized block diagram illustrating merging an ad image into movie frames according to transformation defined in a meta-data file, in one possible embodiment of the present invention.

FIGS. 7a-7c are generalized diagrams illustrating merging an ad image into movie frames according to transformation maintaining scenery integrity via perspective and obstructions, in one possible embodiment of the present invention.

### DETAILED DESCRIPTION

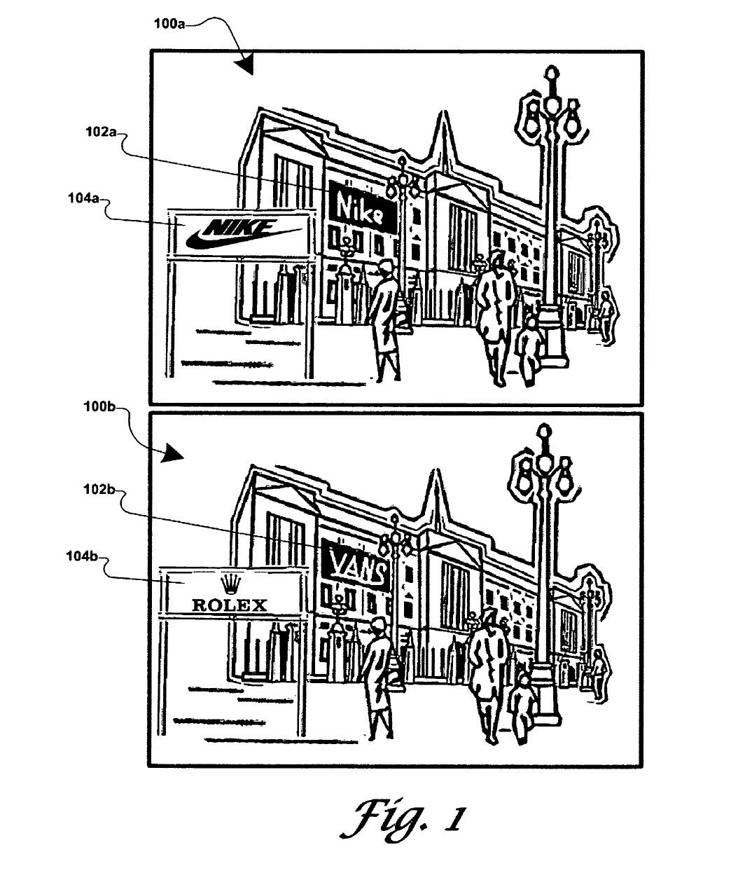

FIG. 1 is a generalized diagram illustrating overview of the present invention, where advertisement content is injected into a movie scene, in one preferred embodiment of the present invention. A single movie (i.e. digital video/media file) frame, represented both as 100a (for a first viewer) and 100b (for a second viewer) may incorporate external advertising content 102a & 102b, and 104a & 104b, respectively.

The movie frame represented as 100a and 100b may include advertising regions upon which external content may be presented. As explained in later figures, advertising content included in external sources (i.e. not part of the original video stream/recorded movie; but may be incorporated into a movie container file containing the video stream—as well as reside anywhere else) may be displayed in combination with the video presented, appearing to be incorporated with the video.

For example, a Viewer A viewing a frame 100a of the video, may see a “Nike” billboard ad 104a and a “Nike” wall ad 102a incorporated into the movie scene. A second person, Viewer B viewing the same frame (denoted herein as 102b) may see an ad for “Rolex” 104b on the same billboard where Viewer A is seeing the “Nike” ad 104a; and, an ad for “Vans” 102b on the same wall where Viewer A is seeing the “Nike” ad 102a.

The ads 102a-104b may be external to the video itself—in its original form—but may be added to the video when it is being watched: either incorporated into the movie stream; or displayed in an overlaid fashion so they appear to be incorporated into the original video. The ads 102a-104b may be incorporated into the video in real time—as the video is being processed and played back; or, in an alternate embodiment, may be incorporated into a movie as part of multiple releases with no further incorporation as the video is being played back.

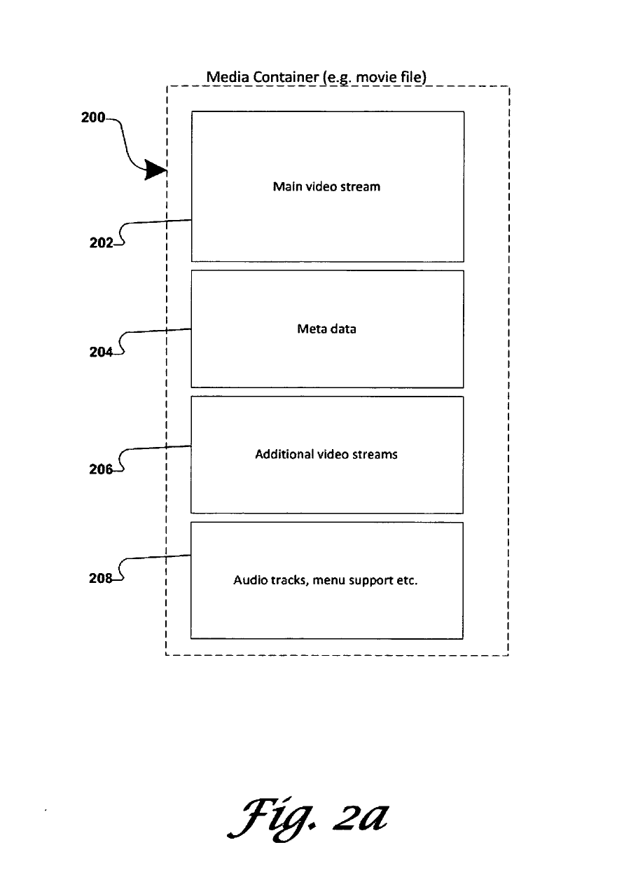

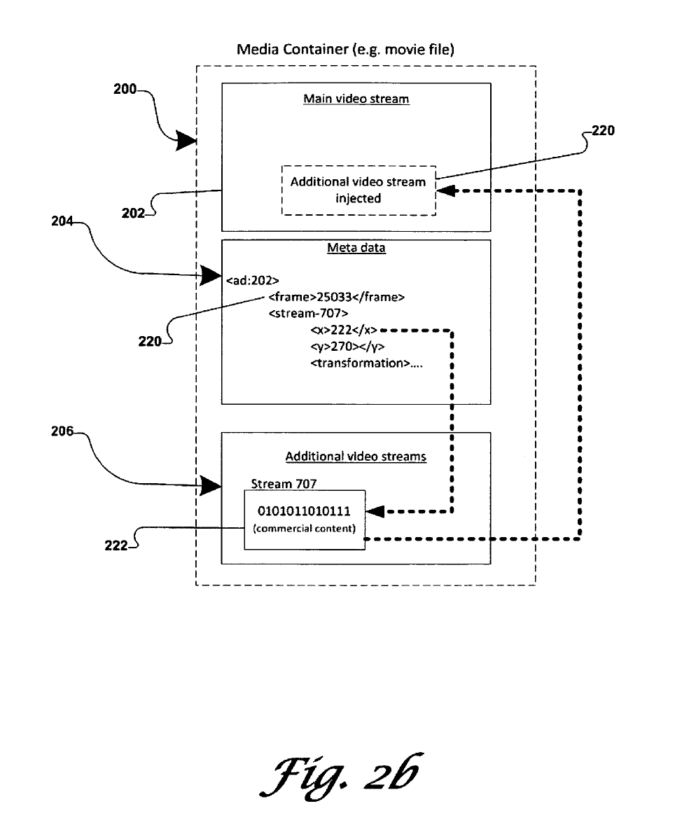

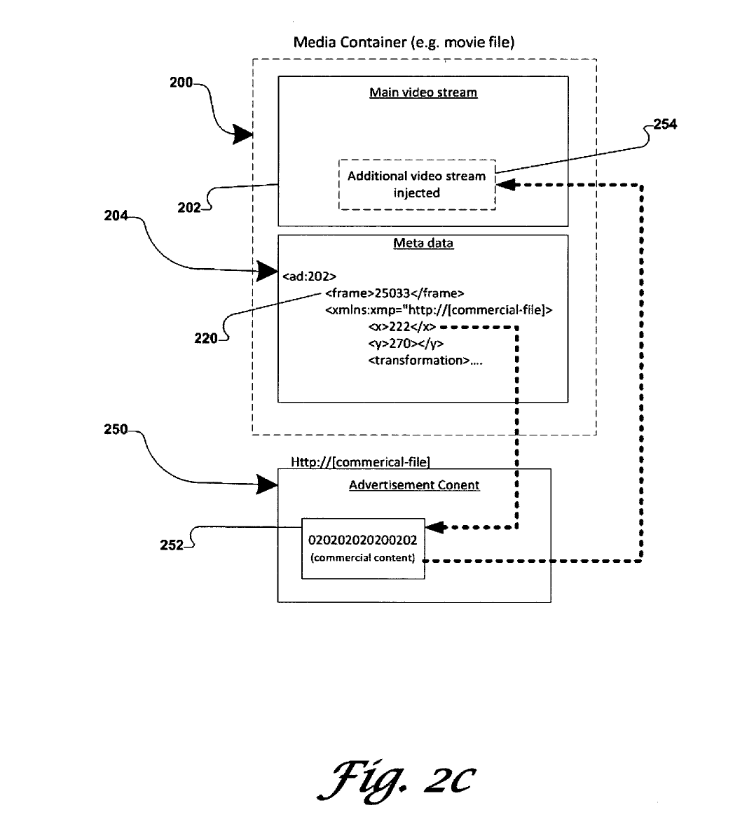

FIGS. 2a-2c are generalized block diagrams illustrating meta data containing references to advertisement content being incorporated into a movie stream, in various possible embodiments of the present invention. FIG. 2a depicts prior art, where a video container 200 (e.g. a MP4 video in the form of a movie file such as “Titanic.mp4”) may contain a movie stream 202, a meta-data section 204 (e.g. XMP formatted containing movie titles, descriptions, creator, actor information, etc.), one or more additional movie streams 206, as well as other media and content 208 such as movie subtitles, navigation menus, one or more audio tracks, etc.

Referring now to FIG. 2b, in one preferred embodiment of the present invention, the meta-data section 204 may contain meta data 220, which, in turn, may contain instructions for embedding an advertisement into a specific video frame(s). In this exemplary illustration: “ad 202” may be embedded in “frame 25033” of the present video at location (222,270) pixels from the top-left corner of the frame; and the advertisement image, contained in “stream 707” may be graphically-transformed in various ways to make it look more realistic and integral to the video frame of the main video stream 202.

In the embodiment illustrated in FIG. 2b, the advertisement “ad 202” may reside in “stream 707” in an “additional video streams” module of the media container 200, as commercial content 222. The meta data 220 may dictate injecting the “stream 707” 222 into a specific frame (e.g. 25033) of the main video stream 202, as content 220. From a viewer's perspective, content 220 may appear integrated into the image of the present movie frame “25033”. The integration may be accomplished via a transformation matrix described in the meta-data 220.

In this specific embodiment, multiple advertisement may be encoded into the single movie container 200. For example, a particular release of the movie “The Hunger Games”, streamed as a file called “hunger_games.mp4” by Netflix®, may contain both the original movie as it had been filmed; and, multiple advertisements which may be displayed as part of that particular release of the movie. A release file streamed over Apple TV® in a file called “hunger_games_{—}2013.mp4” may contain within it a different set of advertisements to be displayed.

In another possible embodiment, illustrated in FIG. 2C, advertisement content 250 may reside outside the main video container 200, for example, on the Internet. A specific advertisement file 250, containing advertisement content 252, may be retrieved and merged with the main video stream 202, as integrated-advertisement content 254. In one possible embodiment, the file retrieval and merging may happen in near-real time, as the movie file is being played back (e.g. live ad injection during the Super Bowl.) In another possible embodiment, the file retrieval and merging may happen prior to packaging a new version of the movie for distribution, including the retrieved file and its advertisement content.

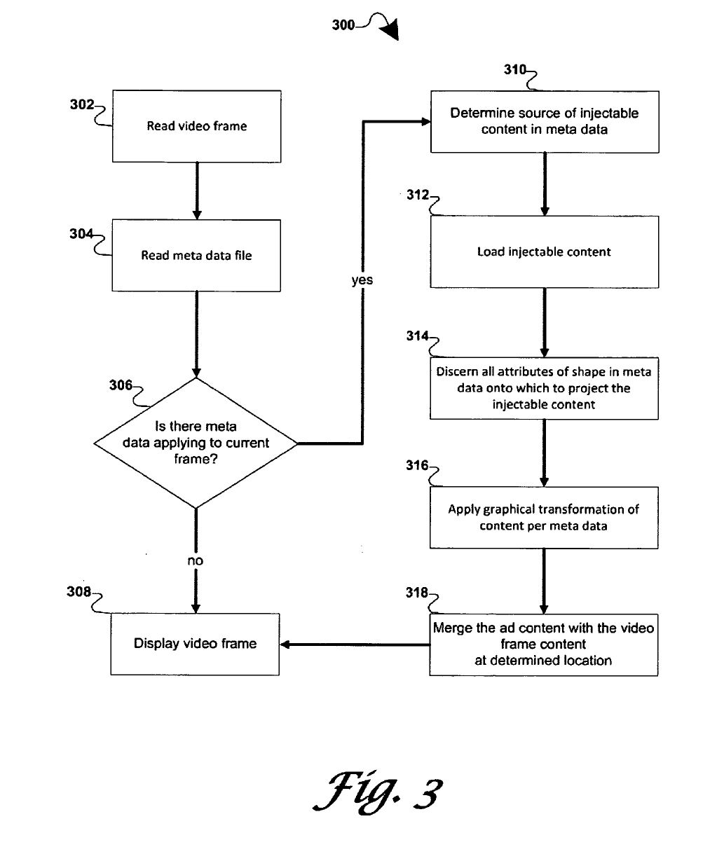

FIG. 3 is a generalized flow diagram illustrating a system in which advertisement content may be injected into a movie frame, in one possible embodiment of the present invention. The mechanism described in flow diagram 300 may take place during movie playback; or, at any point prior as way of generating a new movie version containing merged advertisements.

At step 302, a single video frame may be read/processed (a video is a large collection of video frames played rapidly in sequence.) At step 304, a meta data file may be read and at step 306, it may be determined whether the meta data applies to the specific frame read at step 302.

If it is determined at step 306 that the meta data file does not contain meta data applicable to the frame, at step 308 the video frame may display unchanged. Conversely, if it is determined at step 306 that the meta data file does contain meta data applicable to the video frame, at step 310 the source of injectable content (e.g. an advertisement file) may be determined. For example, in one possible embodiment, as discussed earlier, the injectable content may be an image or video stream embedded in the main video file/container; while in other possible embodiments, the injectable content may reside in separate files in the cloud (i.e. Internet) etc.

At step 314, all representations/attributes of a shape defined in the meta data, defining a surface in the video frame onto which the injectable data is to be projected, may be discerned. For example, the meta data may define a mathematical representation of a shape that is trapezoidal, having vertices at various (X,Y,Z) coordinates, and having wooden texture, with a light source projecting light on it from a certain angle at a certain intensity, etc.

At step 316, a graphical transformation, based on the meta data discerned at step 314, may be applied to the injectable content. The graphical transformation may be computed with the help of functions and routines well known in the prior art, e.g. routines used by animation studios to project an image of a face on a virtual 3D wireframe figure.

At step 318, the transformed injectable content may be merged with the video frame content in accordance with the specifications/attributes discerned at step 314. In one possible embodiment, a new video frame may be outputted where the new video frame contains the original content of the video frame merged with the injectable content, displayed at step 308. In another possible embodiment, the original frame content may remain unchanged and may be displayed, at step 308, overlaid with a display of the injectable content.

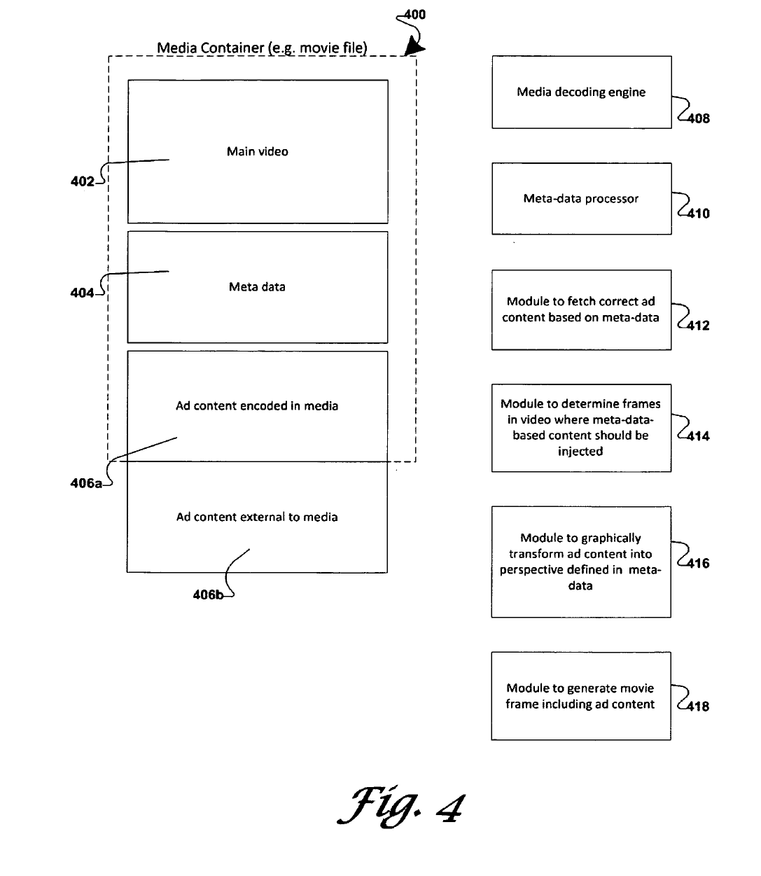

FIG. 4 is a generalized block diagram illustrating components of a system for injecting advertisement content into a video stream, in one possible embodiment of the present invention. A video file 400 may be a media container (e.g. a file in MP4, DivX etc. formats). The video file 400 may contain a main video 402 (e.g. a feature film viewed when the video file 400 is played). The video file 400 may also contain meta data 404. A meta data file commonly contains attributes and element related to the video, that are not in video format—for example, movie captions, navigation menus, hyperlinks and, in the present invention, descriptions of areas in the frames of the video that could be used for advertising.

One type of advertisement content 406a may be encoded within the video file 400. I.e. the video file may ship with, or be streamed with, the included advertisement content 406a. In another possible embodiment, an external advertisement content 406b may be referenced by the meta data 404, but may be external to the video file 400. (e.g. reside in the cloud/Internet, be streamed into separate file on the user's electronic device, etc.)

A media decoding engine 408 is known in the prior art, and is used to decode and play back MPEG-based video (and other types of videos) where video-stream data is encrypted/compressed and/or child video frames require being generated from parent video frames.

In the prior art, a meta-data processing module 410 may be used to process and display meta data, such as movie titles and navigation menus. In the present invention, the meta-data processing module 410 may additionally be used to define portions of the main video 402 capable of being injected with advertising, and/or point to location(s) of advertising content.

A module for fetching advertising content 412 may retrieve the advertising content 406a and/or 406b, depending on whether the advertising content is external or internal to the movie file 400. The meta data module 404 may direct the module for fetching advertising content 412 on where to fetch the advertising content from.

Module to determine frames in video where meta-data-based content should be injected 414 may be used in accordance with module(s) processing the meta data 404. The meta data 404 may contain information identifying a frame(s) where the advertising content 406a/b is to be injected.

A module to graphically transform advertisement content into perspective defined in meta-data 416 may operate in accordance with the modules 410 and 414, mathematically transforming the advertisement content data 406a/b to conform to advertising surfaces/areas in the video frames onto which the advertisement content is to be projected. For example, if the meta data 404 points to a “frame 1054” containing a surface used for advertising, defined as “trapezoid: (X1,Y1) . . . (Xn, Yn), wood texture, 0.5 intensity lighting . . . ” The module 416 may transform a graphic that is part of the advertisement content 406a/b to conform to the above specifications.

The resulting graphical effect from the module 416 may result in a: module to generate movie frame including advertisement content 418, outputting a new video frame which includes content of the original video frame, combined with the graphical effect from module 416. A viewer of the output of module 418 may observe that the advertisement content 406a/b has been integrated into the original video frame in a seamless manner, to where the observer may not be able to tell that the advertisement content 406a/b had not been the original content of the original video frame.

Please note that all the modules in FIG. 4 have been identified as discrete modules 402-418 for illustrative purposes only, with logically-similar functionality being grouped together into discrete modules. It is not the intent of FIG. 4 to suggest a particular segregation/combination of functionality into the module 402-418, but rather only to illustrate one possible way to logically segment components to achieve working of the present invention. In an implementation of the present invention, various hardware/software may be implemented to achieve the sum of all functionality in FIG. 4, with logical/physical modules which may be different from the modules 402-418.

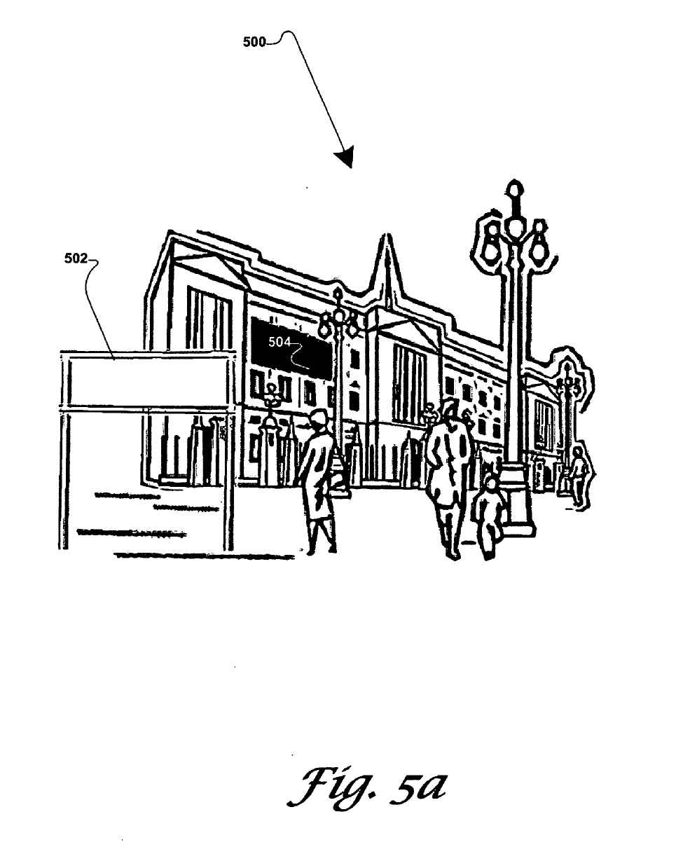

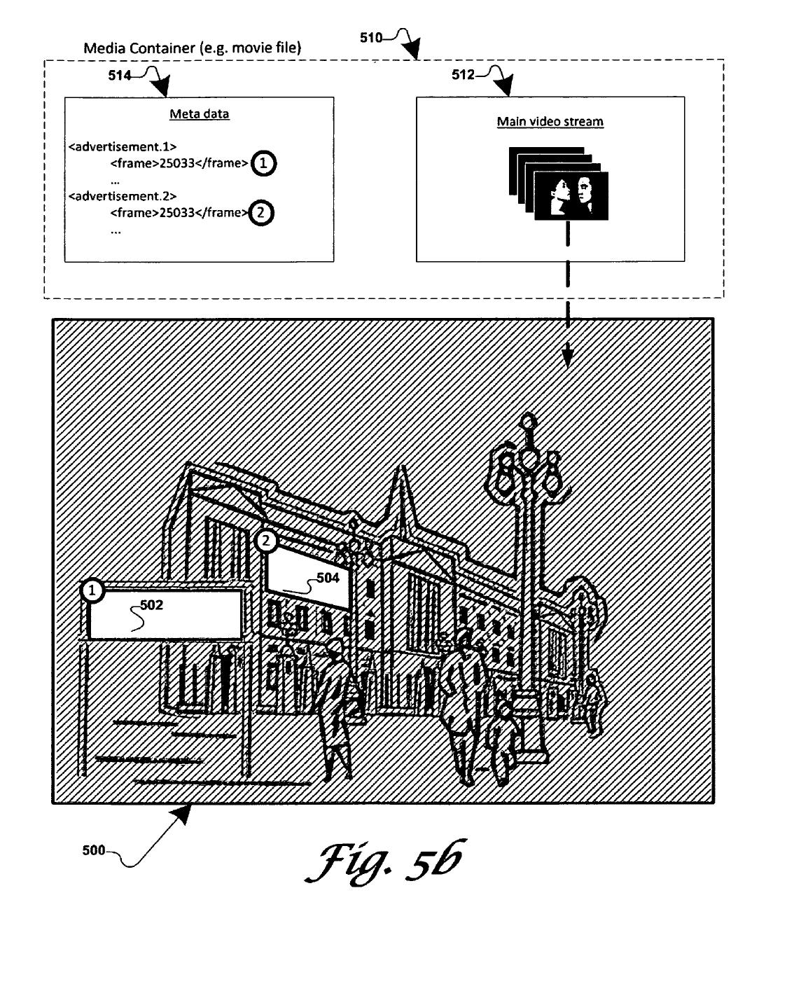

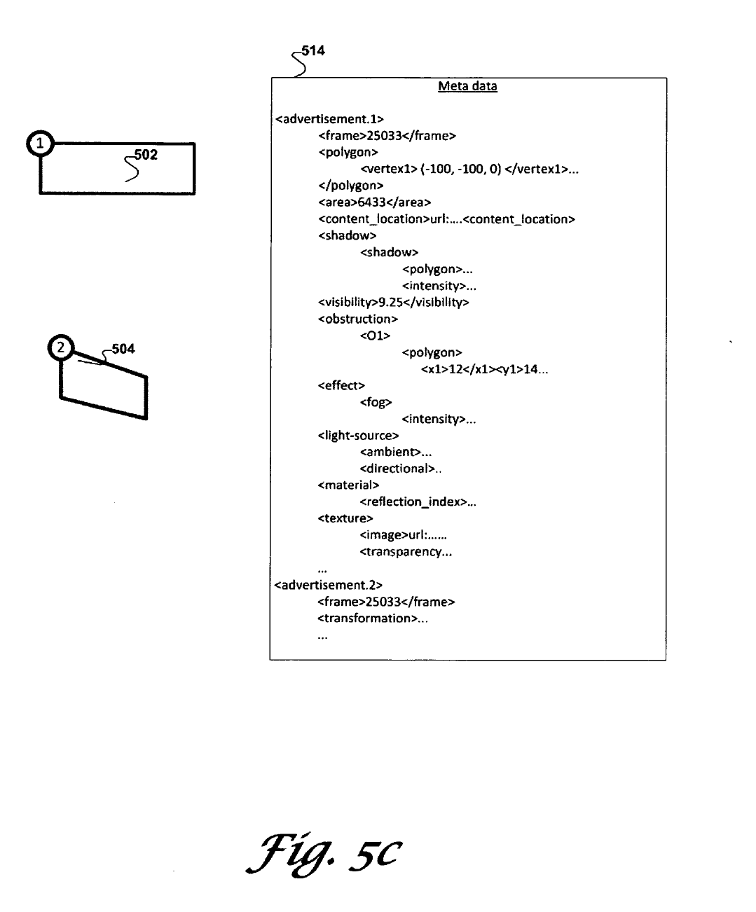

FIGS. 5a-5c are generalized block diagrams illustrating an overview of a method for incorporating external content in a digital video via meta data, in one possible embodiment of the present invention. An original video frame 500 in FIG. 5a may contain advertising surfaces 502 and 504. The advertising surfaces 502 and 504 may be defined in a meta-data file (e.g. meta data incorporated into a video container containing the video frame 500). Please note that the advertising surfaces 502 and 504 are illustrated as “blank” in the movie frame 500 for exemplary purposes only; the advertising surfaces 502 and 504 may be logically-identified portions of an otherwise-normal movie frame (i.e. the movie frame may contain ordinary movie scenery which may later be logically identified as potential advertising area(s).)

Referring now to FIG. 5b, the advertising surfaces 502 and 504 may be defined in a meta data file 514. For example, the advertising surfaces 502 and 504 may be defined in the meta-data file 514 as belonging to a “frame 25033”. The meta-data file 514 may be incorporated into a video file 510, which may also include a main video stream 512 (where the main video stream 512 contains the video frame 500.) In a video containing a sequence of frames like frame 500, the advertising surfaces 502 and 504 may be defined individually for each frame; or, in another possible embodiment, a transformation may be defined in the meta data 514, describing rotation and perspective change of the advertising surfaces 502 and 504 as they transition between the sequence of frames.

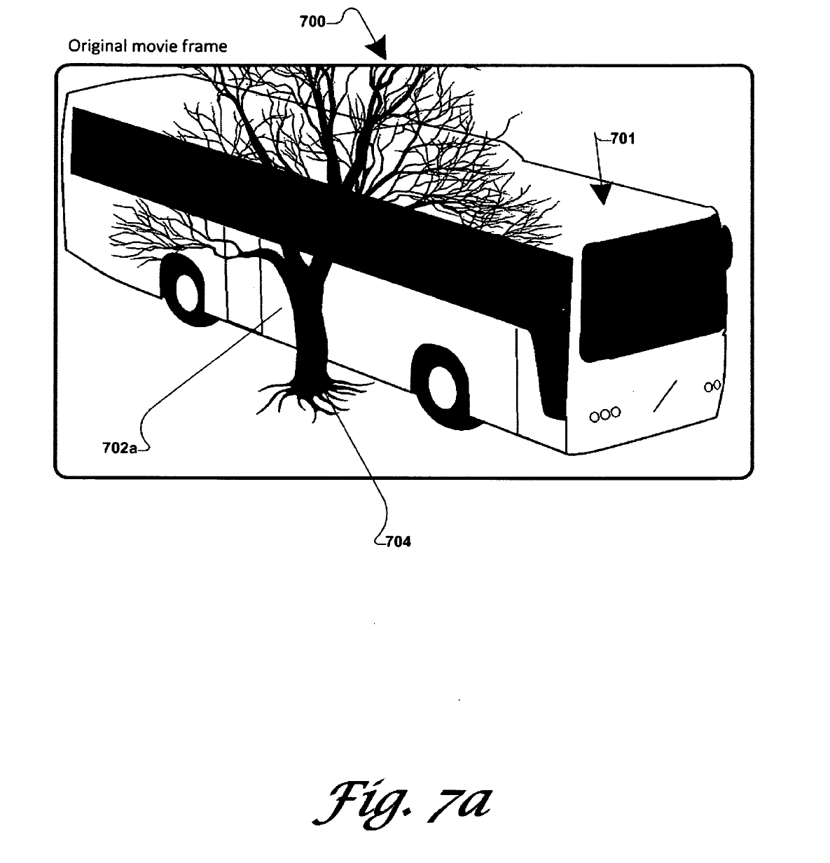

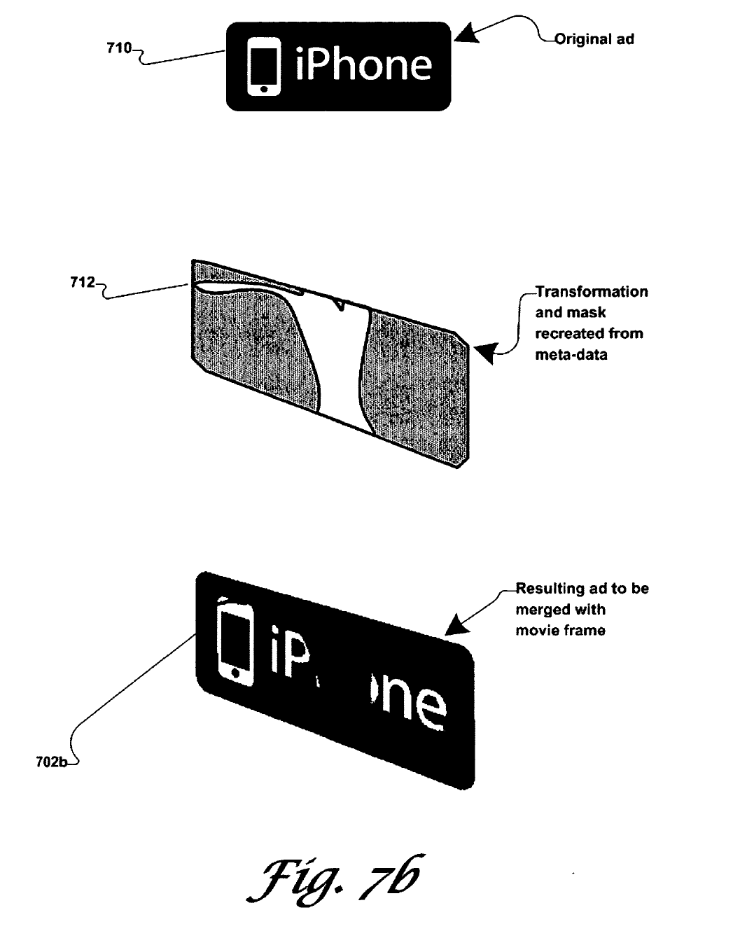

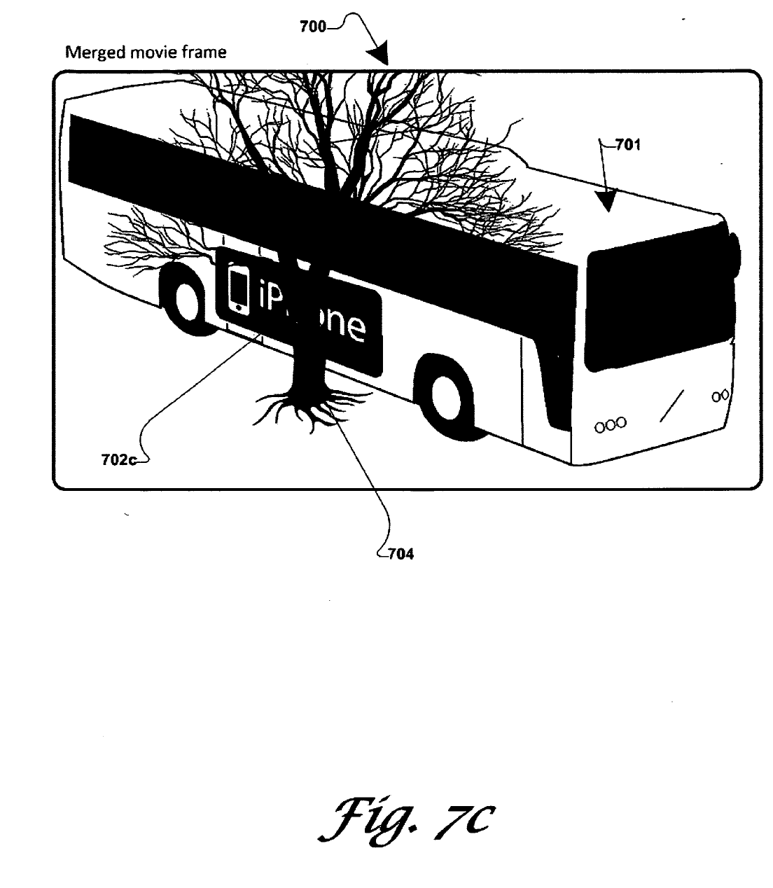

Referring now to FIG. 5c, the meta data file 514 may contain enough information to fully define a transformation of advertising content as it is projected onto the advertising surfaces 502 and 504. For example, the meta data file 514 may contain at least one or more of the following classes/properties/attributes (displayed here in XML format for illustrative purposes):
Advertising ID: a reference to the advertising content to differentiate it from other advertising content. E.g. Apple and Samsung may each place an ad in a 90 minute movie, and the meta data may reference each of the ads individually
Frame: the specific video frame(s) onto which a specific advertisement content is to be applied
Region (e.g. Polygon): a region within the video frame onto which the advertising content may be projected. The region (also referred to as “surface” herein) may be defined as a collection of vertices and other attributes, defining and delimiting an area within the frame (e.g. in pixels) onto which the advertising content may be projected, along with other attributes such as curvature (e.g. if the surfaces is that of a sphere) etc.
Area and other superficial attributes: information used to define the advertising space at a high-level, e.g. area of the ad space which can be used for pricing purposes, where a larger area and/or closer to the frame-center fetches a higher price
Advertising content location: a pointer to the specific advertisement content for each specific advertisement, e.g. a URL pointing to an advertisement image, a file-pointed pointing to an advertisement image within a video file, etc.
Shadow: defines one or more shadows cast over the surface (hence over the advertising content displayed on the surface.) Shadows can be described by their area, color, intensity, source, shape, etc.
Visibility: general visibility of the surface may be described, e.g. as a numerical index or tagged-word (e.g. “clear day” vs. “fog”) and/or any numerical data to be applied to the advertising content to create a visual illusion of lesser/greater visibility to match the scene of the movie in the frame
Obstruction: defines one or more areas of the surface that are obstructed from view. Generally a polygon may be used to define a two-dimensional area (see FIG. 7 as example of a tree obstructing an advertisement on a surface.)
Effect: various optical effects applying to the surface; as example, intense light reflecting, fog producing a gradient degrading focus, etc.
Light source(s): description of one or more light sources illuminating the surface, including location of the sources, intensity, information to re-create the light sourc effect via ray-tracing, whether the light sources are spot-lights or ambient lights, etc.
Material, Texture, Transparency: pre-defined surface types (e.g. “wood”, “metal”, “glass”, “smooth”, “matt”, etc.) used by a graphical rendering engine to project the advertisement content image onto a mathematical representation of a surfaces having the attributes above
Transformation: various transformation matrices and functions may be included in the meta data 514 allowing for efficient projection of the advertisement content onto the surface based on pre-computed values/formulae.

In alternate possible embodiments, the meta data file 514 may contain more and/or different types of information; may be decomposed into any number of meta-data files, wherein the meta-data files reside either in close proximity to each other; or, in disparate places (e.g. a commercial may ship with its own meta data file tailored to a specific video).

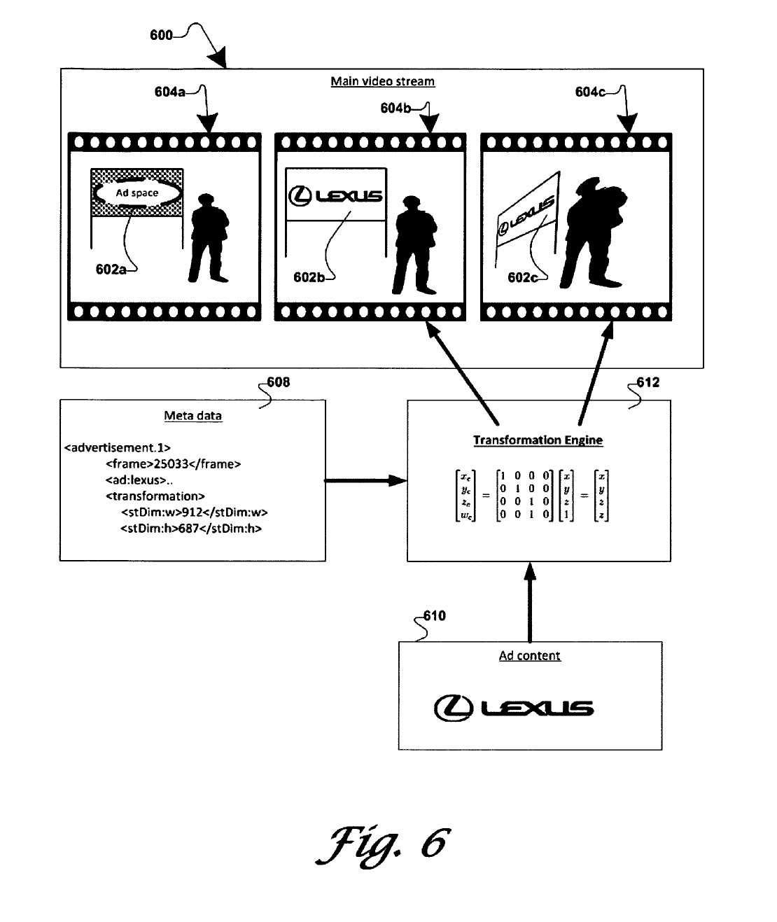

FIG. 6 is a generalized block diagram illustrating merging an ad image into movie frames according to transformation defined in a meta-data file, in one possible embodiment of the present invention. A video stream/file 600 (e.g. a streamed MPEG-4 or DivX file, a BluRay® file, a Youtube® Flash® or WebM video, etc.) may contain a large number of individual frames such as 604a. In the present invention, the frames may contain an area for advertisement 602a. In one possible embodiment, the advertisement area 602a may contain an advertisement as part of original movie, while in other possible embodiments the advertisement area 602a may be digitized to display a blank or any other content for advertisers to advertise in—which during a movie playback for a viewer, would be digitally filled up by an advertisement.

A meta data file 608 may define size, position and transformation (e.g. through a projection matrix) of an advertisement image 610 to be injected into each frame 604a-604c of the video file 600. The meta data file 608 may be part of a main video file containing the video stream 600; or, in other possible embodiments, may be external to the main video file. The meta data file 608 may contain information defining a polygon encompassing the advertisement space 602a-602c, as well as any effects to add (e.g. texture of “surface” of the ad space 602a-602c, such as metallic if ad is on a vehicle), lighting, shadows cast, obstructions etc.

The meta data file 608 may also point to an advertisement content 610 (e.g. an image, a video, etc.) to be infused into the advertisement space 602a-602c of the frames 604a-604c, respectively, of the video file 600. The advertisement content 610 may be contained within the main video file containing the main video stream 600; or, may be contained in the cloud or any other storage mechanism generally available to a movie player playing back the main video 600.

A transformation engine 612 may apply image-projection transformations to the advertisement content 610. The purpose of the image-projection transformation is to combine the advertisement content 610 with an image in each frame 604a-604c of the main video stream 600 such that the advertisement content 610 appears to a viewer to be realistically part of the movie. For example, the advertisement content “Lexus” 610 may be combined with movie frames 604b and 604c on a “billboard” advertising space 602b and 602c, respectively; however, the perspective of the “billboard” advertising space 602b and 602c may be different from frame to frame (as the movie changes camera angles), in which case the advertisement content 610 may be mathematically transformed to by the transformation engine 612 to fit perfectly onto the morphing advertising space 602b-602c.

In one possible embodiment, the transformation engine may be part of a movie's playback mechanism (e.g. a Codec decoder, a BluRay® playback engine, etc.) whereby the advertisement content 610 may be injected into a movie frame visible to the viewer in near-real-time (or rather, during the actual playback.) In an alternate possible embodiment, the main video stream 600 may be injected with the advertisement content 610 prior to transmission of the main video stream 600, as part of a movie container, to a viewer for playback. In other words, multiple video streams, each one containing a different set of ads injected into each video stream, may be distributed.

FIGS. 7a-7c are generalized diagrams illustrating merging an ad image into movie frames according to transformation maintaining scenery integrity via perspective and obstructions, in one possible embodiment of the present invention. To a user viewing the video, advertising content embedded in the video may appear indistinguishable from the rest of the video—i.e. as if the advertisement had been filmed as part of the video. In order to achieve this effect, an image representing the advertising content may need to be transformed: rotated, skewed, tilted, texturized, etc. to perfectly fit both a surface within the video frame the image is being projected upon, and matching all optical properties of the surface.

Referring now to FIG. 7A, a video frame 700 may include an image of a bus 701 and an image of a tree 704. The bus 701 may include an area conducive to placement of an advertisement 702a. In this example, the advertisement area 702a may be on the side of the bus 701. Both the bus 701 and the advertisement area 702a may be partially obstructed by the tree 704 (e.g. when filming the movie, the tree 704 may have been closer to the camera than the bus 700, thus obstructing the bus 700.)

Consequently, placement of an advertisement (i.e. projection of an image representing the advertisement) on the advertisement area 702a needs to take into account various factors to appear realistic, the most obvious of which are: perspective and obstruction. The advertisement area 702a, while originally a rectangle, appears as a trapezoid due to the perspective from which the bus 701 was filmed; and, the tree 704 needs to appear obstructing a portion of the advertising image.

Referring now to FIG. 7b, an advertisement image 710 may need to be projected into the advertisement area 702a on the bus 701 in FIG. 7a. Techniques well known in the prior art may be implemented to project the base image (i.e. advertisement image) onto the surface described in the meta data, including using a mask 712 (which may be used to mask out areas such as area obstructed by the tree). The base image may be tilted, rotated, skewed and otherwise transformed into the same perspective, and having the same general optical properties, as the advertisement area 702a. The resulting new image 702b may include the base image/original ad 710, transformed into the size and perspective of the advertisement area 702a, and having all other properties defined in the meta data, such as areas obstructed, shading, lighting, texture, etc.

Referring now to FIG. 7c, the resulting new image 702b of FIG. 7b may be combined with the original frame 700, resulting in an optical illusion of the bus 701 having an “iPhone” advertisement 702c on its side (being partially obscured by the tree 704). In one possible embodiment, the new image 702b may be combined with the original frame 700 to create a new video frame, which is then rendered for the viewer (either in close-to-real-time, as in the case of video streaming, or a new video may be produced from new frames and saved as a new video file, including a new set of built-in advertising, for playing at a later time.) In another possible embodiment, the new image 702b may be displayed overlaying the original frame 700 resulting in an illusion of one combined image.

While various embodiments of the present invention have been described in detail, it is apparent that further modifications and adaptations of the present invention will occur to those skilled in the art. However, it is to be expressly understood that such modifications and adaptations are within the spirit and scope of the present invention.

What is claimed is:

1. A computer-implemented method comprising:
providing a video in digital format wherein the video comprises a sequence of video frames;
providing meta-data wherein the meta-data defines at least one surface in at least one of the video frames;
providing an image, wherein the image is external to the video;
incorporating the image into the at least one surface; and
displaying the sequence of video frames wherein the sequence of video frames includes the image incorporated into the at least one surface.

2. The method of claim 1, wherein the meta-data is stored in association with the video.

3. The method of claim 2, wherein the video is comprised of the meta-data and the sequence of video frames.

4. The method of claim 1, wherein the image is an advertisement.

5. The method of claim 1, wherein the surface is a polygon.

6. The method of claim 1, wherein the surface represents a three-dimensional object.

7. The method of claim 1, wherein the meta-data contains one or more of the following attributes: vertices of the surface and/or texture of the surface and/or lighting of the surface and/or a shadow cast on the surface and/or one or more shapes obstructing the surface and/or curvature of the surface and/or a transformation matrix and/or transparency of the surface.

8. The method of claim 7, wherein the image is projected onto the surface via a transformation function.

9. The method of claim 8, wherein the transformation function takes as input the one or more of the meta-data attributes.

10. The method of claim 1, wherein the video is part of a real-time streaming broadcast.

11. The method of claim 1, wherein a plurality of images are incorporated into the sequence of video frames.

12. The method of claim 11, where the number of images in the plurality of images equals the number of frames in the sequence of frames, and wherein each of the images of the plurality of images is incorporated within an individual frame in the sequence of video frames.

13. The method of claim 1, wherein the image is incorporated into the sequence of video frames, wherein the meta-data defines an individual transformation of the image prior to its incorporation into each of the frames in the sequence of frames.

14. The method of claim 1, wherein the image is displayed separately from the surface in a layer overlapping the surface.

15. The method of claim 1, wherein the meta-data is stored in two or more separate files.

16. The method of claim 15, wherein an additional meta-data file defining an advertisement content, and the advertisement content, comprising an image, are both stored in association with each other, separately from a file comprising the video.

17. A system for facilitating incorporation of advertising content into a video, comprising:
One or more processors;
A digital video processing component, executed by the one or more processors, that decodes and processes a plurality of frames comprising a digital video;
A meta-data processing component, executed by the one or more processors, that defines transformation of an image into a region within at least one of the plurality of frames;
A transformation component, executed by the one or more processors, that transforms the image based on the defined transformation;
A combination component, executed by the one or more processors, that combines the transformed image with the at least one of the plurality of frames, wherein the combination places the transformed image in a region defined by the meta-data processing component.

18. The system of claim 17, wherein the meta-data component defines the transformation based on one or more of the following factors: vertices of the region and/or texture of the region and/or lighting of the region and/or a shadow cast on the region and/or one or more shapes obstructing the region and/or curvature of the region and/or a transformation matrix and/or transparency of the region.

19. The system of claim 17, wherein the combination component further outputs a new digital video, wherein the new digital video comprises the original digital video graphically combined with the transformed image.

20. The system of claim 17, wherein the meta-data processing component further defines a location where the image resides.

21. The system of claim 20, wherein the transformation component further retrieves the image prior to transforming the image.

22. The system of claim 20, wherein the video processing component further plays back the digital video.

23. The system of claim 22, wherein one or more of the meta-data processing component, the transformation component, the combination component execute during the playback of the digital video.

24. The system of claim 20, wherein the processing component further retrieves the digital video as a video stream.

25. The system of claim 20, wherein the meta-data processing component further defines a first transformation of the image into a first region within a first frame, and a second transformation of the image into a second region within a second frame.

26. The system of claim 25, wherein the transformation module transforms the first image based on the first defined transformation, and wherein the transformation module transforms the second image based on the second defined transformation.

27. The system of claim 26, wherein the combination component first combines the first transformed image with the first frame, wherein the first combination places the first transformed image in a first region defined by the meta-data processing component in the first transformation, and wherein the combination component secondly combines the second transformed image with the second frame, wherein the second combination places the second transformed image in a second region defined by the meta-data processing component in the second transformation.
